(19) United States
(12) Patent Application Publication
(10) Pub. No.: US 2016/0210631 A1
(43) Pub. Date: Jul. 21, 2016

(54) SYSTEMS AND METHODS FOR FLAGGING POTENTIAL FRAUDULENT ACTIVITIES IN AN ORGANIZATION

(71) Applicant: Wipro Limited, Bangalore (IN)

(72) Inventors: Guha Ramasubramanian, Bangalore (IN); Shreya Manjunath, Bangalore (IN); Siddharth Mahesh, Chennai (IN); Raghuraman Ranganathan, Bangalore (IN)

(21) Appl. No.: 14/661,298

(22) Filed: Mar. 18, 2015

(30) Foreign Application Priority Data
Jan. 15, 2015 (IN) 232/CHE/2015

(51) Int. Cl. G06Q 20/40

(52) U.S. Cl. CPC G06Q 20/4016

(57) ABSTRACT

An organizational fraud detection (OFD) system and method for flagging one or more transactions as a potential fraudulent activity, in an organization is disclosed. The OFD system comprises: a processor; and a memory communicatively coupled to the processor, wherein the memory stores processor-executable instructions, which, on execution, cause the processor to: receive a suspected transaction for investigation, classify the suspected transaction into one or more groups of fraudulent activity; select, based on the classification, a set of investigation rules for investigating the suspected transaction; determine, based on data selection rules, the data associated with the suspected transaction; ascertain an accuracy score and an impact score associated with the suspected transaction; and classify the suspected transaction as a potential fraudulent activity on at least one of the accuracy score and the impact score exceeding a pre-defined threshold.

This application claims the benefit of Indian Patent Application Serial No. 232/CHE/2015 filed Jan. 15, 2015, which is hereby incorporated by reference in its entirety.

### FIELD

The present subject matter is related, in general to compliance monitoring of transactions in an organization and, in particular but not exclusively to, a method and system for flagging one or more transactions as a potential fraudulent activity, in an organization.

### BACKGROUND

Occupational fraud typically covers a wide range of misconduct by executives and employees of organizations who leverage their official roles to benefit from misapplication of the organization's resources. The impact of fraud may be significant. One of the challenges in building an estimate is that often the fraud may go undetected for a number of years and damage caused by a specific fraud might be difficult to assess. Organization frauds may cause significant impacts to an organization's reputation. The organization may face concerns from regulatory authorities around the lack of controls and there may be additional audit costs involved.

Further, the damage caused by a fraud typically tends to increase dramatically if there is collusion involved. There may be a correlation between a collusive fraud and the lowered rate of detection, or time for the fraud to be uncovered. This naturally makes the detection of collusive fraud more critical. Existing solutions in the space focus on basic correlations to identify anomalies. While this is useful, the challenge with this approach is that the consequent actions arising from the fraud is not uncovered. Likewise, the ability to identify collusive behavior is required to really identify significant fraud relative to smaller incidents.

### SUMMARY

In one embodiment, an organizational fraud detection (OFD) system, for flagging one or more transactions as a potential fraudulent activity, in an organization is disclosed. The OFD system comprises: a processor; and a memory communicatively coupled to the processor, wherein the memory stores processor-executable instructions, which, on execution, cause the processor to: receive a suspected transaction for investigation, classify the suspected transaction into one or more groups of fraudulent activity; select, based on the classification, a set of investigation rules for investigating the suspected transaction; determine, based on data selection rules, the data associated with the suspected transaction; ascertain an accuracy score and an impact score associated with the suspected transaction; and classify the suspected transaction as a potential fraudulent activity on at least one of the accuracy score and the impact score exceeding a pre-defined threshold.

In another embodiment, a computer implemented method for flagging one or more transactions as a potential fraudulent activity, in an organization is disclosed. The method comprises: receiving a suspected transaction for investigation; classifying the suspected transaction into one or more groups of fraudulent activity; selecting, based on the classification, a set of investigation rules for investigating the suspected transaction; determining, based on data selection rules, the data associated with the suspected transaction; ascertaining an accuracy score and an impact score associated with the suspected transaction; and classifying the suspected transaction as a potential fraudulent activity on at least one of the accuracy score and the impact score exceeding a pre-defined threshold.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary block diagram of an Organizational Fraud Detection (OFD) system according to some embodiments of the present disclosure.

FIG. 2 is a flow diagram of a method of flagging one or more transactions as a potential fraudulent activity according to some embodiments of the present disclosure.

FIG. 3 illustrates an exemplary occupational graph used to perform collusion network analysis according to some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Systems and methods for flagging one or more transactions as a potential fraudulent activity in an organization are described herein. The systems and methods may be implemented in a variety of computing systems. The computing systems that can implement the described method(s) include, but are not limited to a server, a desktop personal computer, a notebook or a portable computer, a mainframe computer, and in a mobile computing environment. Although the description herein is with reference to certain computing systems, the systems and methods may be implemented in other computing systems, albeit with a few variations, as will be understood by a person skilled in the art.

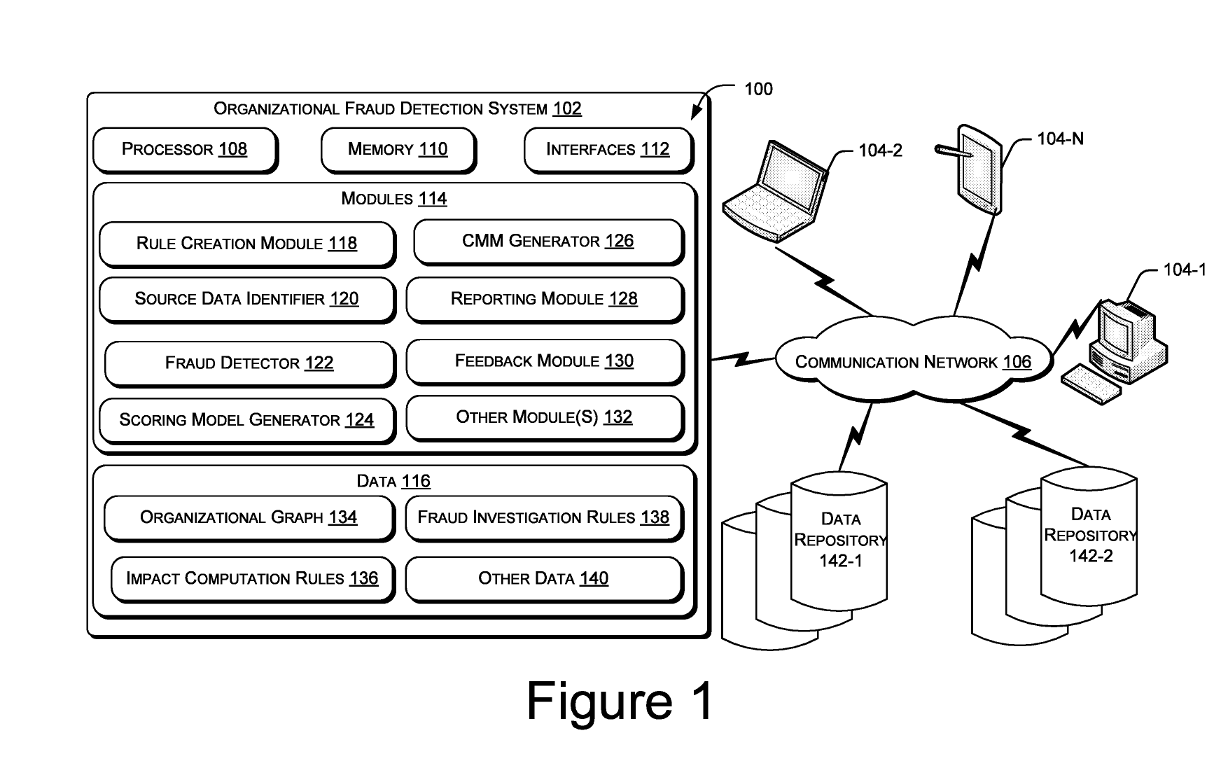

The working of the systems and methods for flagging one or more transactions as a potential fraudulent activity, in an organization is described in greater detail in conjunction with FIG. 1-3. It should be noted that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates a network environment 100 implementing a organizational fraud detection (OFD) system 102 for flagging one or more transactions as a potential fraudulent activity according to some embodiments of the present subject matter. In one implementation, the OFD system 102 may be included within an existing information technology infrastructure of an organization. For example, the content recommendation system 102 may be interfaced with the existing data warehouses, data marts, data repositories, database and file management system(s), of the organization.

The OFD system 102 may be implemented in a variety of computing systems, such as a laptop computer, a desktop computer, a notebook, a workstation, a mainframe computer, a server, a network server, a media player, a smartphone, an electronic book reader, a gaming device, a tablet and the like. It will be understood that the OFD system 102 may be accessed by users through one or more client devices 104-1, 104-2, 104-N, collectively referred to as client devices 104. Examples of the client devices 104 may include, but are not limited to, a desktop computer, a portable computer, a mobile phone, a handheld device, a workstation. The client devices 104 may be used by various stakeholders or end users of the organization, such as project managers, database administrators and heads of business units and departments of the organization. As shown in the figure, such client devices 104 are communicatively coupled to the OFD system 102 through a network 106 for facilitating one or more end users to access and/or operate the OFD system 102. In some examples, the OFD system 102 may be integrated with the client devices 104.

The network 106 may be a wireless network, wired network or a combination thereof. The network 106 can be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 106 may include a variety of network devices, including routers, bridges, servers, computing devices, storage devices, etc.

In one implementation, the OFD system 102 includes a processor 108, a memory 110 coupled to the processor 108 and interfaces 112. The processor 108 may be implemented as one or more microprocessors, microcomputers, microcontrollers, digital signal processors, central processing units, state machines, logic circuitries, and/or any devices that manipulate signals based on operational instructions. Among other capabilities, the processor 108 is configured to fetch and execute computer-readable instructions stored in the memory 110. The memory 110 can include any non-transitory computer-readable medium known in the art including, for example, volatile memory (e.g., RAM), and/or non-volatile memory (e.g., EPROM, flash memory, etc.).

The interface(s) 112 may include a variety of software and hardware interfaces, for example, a web interface, a graphical user interface, etc., allowing the OFD system 102 to interact with the client devices 104. Further, the interface(s) 112 may enable the OFD system 102 respectively to communicate with other computing devices. The interface(s) 112 can facilitate multiple communications within a wide variety of networks and protocol types, including wired networks, for example LAN, cable, etc., and wireless networks such as WLAN, cellular, or satellite. The interface(s) 112 may include one or more ports for connecting a number of devices to each other or to another server.

In one example, the OFD system 102 includes modules 114 and data 116. In one embodiment, the modules 114 and the data 116 may be stored within the memory 110. In one example, the modules 114, amongst other things, include routines, programs, objects, components, and data structures, which perform particular tasks or implement particular abstract data types. The modules 114 and data 116 may also be implemented as, signal processor(s), state machine(s), logic circuitries, and/or any other device or component that manipulate signals based on operational instructions. Further, the modules 114 can be implemented by one or more hardware components, by computer-readable instructions executed by a processing unit, or by a combination thereof.

In one implementation, the modules 114 include a rule creation module 118, a source data identifier 120, scoring model generator 122, a fraud detector 124, a Consequence Management Matrix (CMM) generator 126, a reporting module 128, a feedback module 130, and other module(s) 132. The other modules 132 may perform various miscellaneous functionalities of the OFD system 102. It will be appreciated that such aforementioned modules may be represented as a single module or a combination of different modules.

In one example, the data 116 serves, amongst other things, as a repository for storing data fetched, processed, received and generated by one or more of the modules 114. In one implementation, the data 116 may include, for example, organization graphs 134, impact computation rules 136, fraud detection rules 138, and other data 140. In one embodiment, the data 116 may be stored in the memory 110 in the form of various data structures. Additionally, the aforementioned data can be organized using data models, such as relational or hierarchical data models. The other data 136 may be used to store data, including temporary data and temporary files, generated by the modules 114 for performing the various functions of the OFD system 102.

In one implementation, the OFD system 102 is communicatively coupled with data repositories such as data repository 142-1 and data repository 142-2. The data repositories may comprise one or more commercially available data storage media, such as compact discs, magnetic tapes, SATA disks, and so on. The data repositories 142-1 and 142-2 may also implement various commercially available database management systems, such as Oracle™ Database, and Microsoft™ SQL Server. In one implementation, the data repository 142-1 and 142-2 may be implemented within the OFD system 102. In one example, the data repository 142-1 and 142-2 may be understood to include data warehouses, database management systems, data marts, and so on.

The working of the OFD system will now be described in detail. Processor 108 may interact with an organization framework and receive a suspected transaction for investigation. In this case, a suspected transaction corresponds to a transaction that is suspected to be fraudulent. In some embodiments, the transaction that is suspected to be fraudulent may be identified manually by an administrator and provided to processor 108 to verify if the transaction is actually fraudulent or has wrongly been identified as a suspected fraudulent transaction. In other embodiments, the suspected transaction may be identified automatically based on that transaction deviating from a predefined normal behavior. In one example, the transaction may be compared with previous or historical records of the transaction to identify any deviations that may indicate an anomalous or suspected transaction. The suspected transaction may include one or more sub-transactions. The sub-transactions may correspond to various events that occur in an organization or enterprise environment. To identify sub-transactions associated with a transaction, one or more sub-transactions associated with the organization may be monitored. Thereafter, breaches in the monitored sub-transactions may be identified and then patterns in the identified breaches may be determined. An accuracy score and an impact score may then be ascertained for the sub-transactions based on the determined patterns. Computation of the accuracy score and the impact score is explained in detail later. The sub-transactions may then be classified as a single fraudulent transaction based on the determined patterns and one or more of the accuracy score and the impact score.

After receiving the suspected transaction, processor 108 may classify the suspected transaction into one or more groups of fraudulent activity. The groups may each correspond to a domain area associated with the fraud. Processor 108 may analyze various parameters associated with the suspected transaction and accordingly classify the suspected transaction into one or more groups. For example, the suspected transaction may be classified as a case of impersonation, improper payments, credential sharing, false claims, or duplicate claims, etc. It is to be noted that the list of fraudulent activity disclosed herein is for illustrative purposes and that other fraudulent activities may also be considered without deviating from the scope of the present disclosure.

Once the suspected transaction is classified into one or more groups, rule creation module 118 may automatically create a set of investigation rules to investigate the suspected transaction. The context for each domain of occupational fraud may be provided as parameterized input to the rule creation module 118 for automatic rule set creation. Rule sets generated by the rule creation module 118 allow the users to uncover deviations from expected or normal behavior, by correlating parameters from specified data sets as applicable to the domain in question. The rule creation module may use a model based approach to uncover all the scenarios for a specific domain based on the parameterized context. For example, a People, Location, Object, Time (PLOT) model may be used to cover scenarios by considering the people involved in the suspected transaction, the location where the suspected transaction is assumed to have occurred, the object of the suspected transaction, and the time of the suspected transaction.

The rule creation module 118 automatically creates rules sets in the form of scenarios. Each scenario is constructed based on a combination of various filters for each element of the PLOT model based on the parameterized context of the domain. A combination of scenarios forms the rule set for the domain. For example, individual or people involved in the suspected transaction may be filtered based on whether they are employees at risk of attrition vs. employees serving notice vs. normal employees, full time employees vs. temporary/part-time staff/contractors, lower level employees vs. higher level employees, etc. The above filters could be used to create a much more specific and relevant filter condition that is applicable in the business context.

The location associated with the suspected transaction may also be factored to create scenarios. For example, rule creation module 118 may create scenarios differently based on whether the suspected transaction is associated with a sensitive area vs. general access areas, business vs. non-business operations locations, or application/knowledge management portals. These filters could be used to create a much more specific and relevant filter condition for specific locations. Similarly, objects involved in the suspected fraud and the time of occurrence may also be considered to create relevant scenarios. The objects may be filtered based on whether they are data exfiltration targets, competitive advantage targets, arson targets, etc. Time patterns such as working hours vs. non-working hours, business days vs. weekends/holidays, periods entailing access to sensitive data (e.g. period prior to financial results) may also be considered by rule creation module 118 while modeling the scenarios. Once the investigation rules are created, they may be stored as fraud investigation rules 138.

For each of the filters, certain trigger variables may be defined with acceptable levels of values for these triggers. A single primary level rule works by combining various filters of the PLOT model with their trigger variables if any. The trigger variables may also be determined through sophisticated statistical patterns. These statistical methods include, but are not limited to, averages, mean, moving average, trend analysis, regression analysis, time series analysis etc.

In addition to the anomaly rules based on generic filter conditions for a group of employees, the behavior of a particular individual might be very idiosyncratic in comparison to his/her own past behavior. This historical trend analysis may also be included as part of the rule set for primary level detection.

The primary level anomaly rules in turn form the basis for aggregate level anomaly detection where higher level intelligence may be built through iterative linkage of underlying primary level anomalous incidents.

On creation of various investigation rules to investigate the suspected transaction by the rule creation module 118, the source data identifier 120 may automatically determine data sources needed for each rule in the rule set created by the rule creation module 118 using data selection rules. The source data identifier 120 may determine the relevant data sources based on the various validations required for each element in the PLOT model. The data selection rules may enable selection of the data sources based on the relevance of the data source to the particular investigation rule, the quality of data, and the ease of access of the data. The data sources could include structured data as well as unstructured data. Structured data may include, but is not limited to, physical access records, network access and security logs, application transaction data, application logs, HR profile records, etc. Further, unstructured data may include, but is not limited to, email data, video conference logs, internet activity, video surveillance logs, social networking records, cell phone records, etc.

Fraud detector 122 may use the rules created by the rule creation module 118 and the data sources determined by the source data identifier 120 to identify if the suspected transaction could be a possible fraudulent transaction. Fraud detector 122 may query the data sources determined by the source data identifier 120 for data specific to the rule sets created by the rule creation module 118. For example, fraud detector 122 may query one or more of data repository 142-1 and data repository 142-2 to retrieve the data associated with the suspected transaction. Fraud detector 122 may include two levels of anomaly detection and may query the data sources for both these levels. Primary level anomaly detection may be performed by the fraud detector 122 to unearth anomalies based on deviations from expected patterns of behavior. The fraud detector may flag the suspected transaction as a potential fraud activity if the anomalies indicate a deviation from expected patterns. Queries may be generated based on the filters and trigger values of the PLOT model and the appropriate data fields in the selected data sets. Thereafter, fraud detector 122 may perform aggregate level anomaly detection by looking at anomalous events taken together rather than in isolation. Aggregate level anomaly detection aims to discover broader patterns of behavior such as collusion and anomaly chains. Fraud detector 122 may use anomalous instances discovered at the primary level to determine aggregate level anomalies. Aggregate level anomaly detection helps piece together all the elements of the fraud to enable users to connect the dots between anomalies to better understand the larger fraud story. Aggregate level anomaly detection also improves the evidentiary value of the anomalies by linking related anomalies. Aggregate level anomalies have a comparatively lower false positive rate as the confirmatory evidence is provided by linked anomalies. Aggregate level anomaly flag may be set to True if there is a pattern between the discrepancies either between multiple events or between multiple users or both.

A number of analysis methodologies may be used by fraud detector 122 to uncover aggregate level anomalies. For example, a collusion network analysis may be used if anomalous behavior is not restricted to one individual but several individuals related to one other, a third party collusion analysis may be used if anomalous behavior is indicative of collusion between one or more employees and third party vendors, an anomaly chain analysis may be used to perform an end to end analysis that links a particular anomaly to other anomalous events that facilitated different anomalies. Further, an intersection analysis may be used if the same anomalous behavior is indicated by multiple algorithms of the same domain, a consequent event tracking may be performed if an individuals' actions post an anomalous behavior act as confirmatory indicator of initial anomalous action, and an intent analysis may be used to cover prediction of possible motives for confirmed anomalous activities. Further, one or more of an organizational graph, related sub-transactions, and related transactions may be analyzed by processor 108 to determine patterns in the suspected transaction. The analysis may ascertain relationships between the users involved in one or more of the related sub-transactions, related transactions, and sub-transactions of the suspected transaction to identify group involvement in the suspected transaction. Thereafter, one or more of the accuracy score and the impact score associated with the suspected transaction may be revised based on at least one of the determined patterns and the ascertained relationships. For example, group involvement in the suspected transaction may cause a far more serious situation and this may be indicated by revising the impact score to a higher value.

Once the fraud detector 122 determines that the suspected transaction is a probable fraudulent activity, the scoring model generator 124 may ascertain an accuracy score and an impact score for the suspected transaction. The accuracy score may be computed based on availability and number of corroborating sources, overall false positive rate for the scenario and quality of data sources (lower accuracy if data gaps exist etc.). The impact score may be computed based on the value of the transaction and also the domain criticality. The scoring model generator 124 may assign a default weight to each of the parameters while calculating the accuracy score and the impact score. These default weights may then be automatically updated based on feedback after the investigation process. The suspected transaction may be classified as a potential fraudulent activity if one or more of the accuracy score and the impact score exceed a pre-defined threshold.

Subsequently, the Consequence Management Matrix (CMM) generator 126 may generate the actions to be taken if the suspected transaction is determined to be a fraudulent activity. The subsequent actions may be defined by the CMM generator 126 based on the accuracy score and the impact score computed for the scenario. The subsequent actions may include, but are not limited to, blocking the suspected transaction, accepting the suspected transaction but sending real time alert for immediate tracking by investigators, accepting transaction with tracking in batch mode etc. The anomalous instance may then be assigned to an investigating user and if the aggregate level anomaly flag is set to true, then all the related anomalous events may be collated and assigned to the same investigating user. The CMM generator 126 may be self-learning and may ‘learn’ from feedback provided by the investigating user to generate more relevant actions. The feedback provided to the CMM generator 126 may indicate if an action specified by the CMM generator 126 was relevant or not. The threshold values and the subsequent actions taken may be continually updated. If a certain anomaly was unblocked by the investigating user for a certain impact and accuracy score, the CMM is updated such that anomalies with similar combination of threshold values will not be blocked in future. With each response/feedback by the investigating user, the CMM generator 126 learns to calibrate its future response by determining the actual threshold values for which a particular action should be triggered or suggested. Additionally, based on the feedback received from the investigation user, the rule creation module 118 may determine modifications to be made to the investigation rules. Similarly, the source data identifier 120 may determine modifications that may have to be made to the data selection rules. The investigation rules and data selection rules may then be amended accordingly.

An example of the actions performed by the CMM generator 126 based on the value of the accuracy score and the impact score is given below:

| | | Aggregate | |
|---|---|---|---|
| Impact | Accuracy | level | |
| score | score | anomaly flag | Subsequent action |
| High | Low | False | Block transaction. Assign to |
| <Threshold | <Threshold | | investigating user and send |
| value> | value> | | real time alert for immediate |
| | | | tracking |
| Low | High | False | Accept transaction. Assign to |
| <Threshold | <Threshold | | investigating user and send |
| value> | value> | | real time alert for immediate |
| | | | tracking |
| Low | Low | False | Accept transaction with |
| <Threshold | <Threshold | | tracking in batch mode |
| value> | value> | | |
| Low | High | True | Block transaction, collate all |
| <Threshold | <Threshold | | related events and assign to |
| value> | value> | | same investigating user. Send |
| | | | real time alert for immediate |
| | | | tracking |

The feedback regarding the anomalous instances indicating if the cases are true positives or false positives is provided to the feedback module 130 by investigating users. This feedback is used as training data for the machine learning algorithms of the feedback module 130. A variety of supervised Machine Learning models such as, but not limited to, Decision Trees, Bayesian Networks such as Naïve Bayes Classifiers, Neural networks, Support Vector Machines, etc. may be used to learn from the feedback. The feedback module 130 determines the machine learning model with the greatest predictive accuracy for that particular primary level/aggregate level algorithm. The ROC curve of different machine models can be visualized for each primary level/aggregate level algorithm in the system. The system automatically determines the machine learning model with the greatest predictive accuracy for that particular detection algorithm and tweaks it based on the selected machine learning model. Thus the algorithm set is self-learning i.e. automatically updated based on feedback.

The decrypted data of the anomalous instances may be reported by the reporting module 128 to users (including non-investigating management users) based on defined access controls. In addition to the report for each scenario, the reporting module 128 may also include dashboards depicting the picture of the overall state of anomaly detection and provide a visual representation of aggregate frauds. Various stakeholders may access the reports via one of client devices 104-1, 104-2, 104-n.

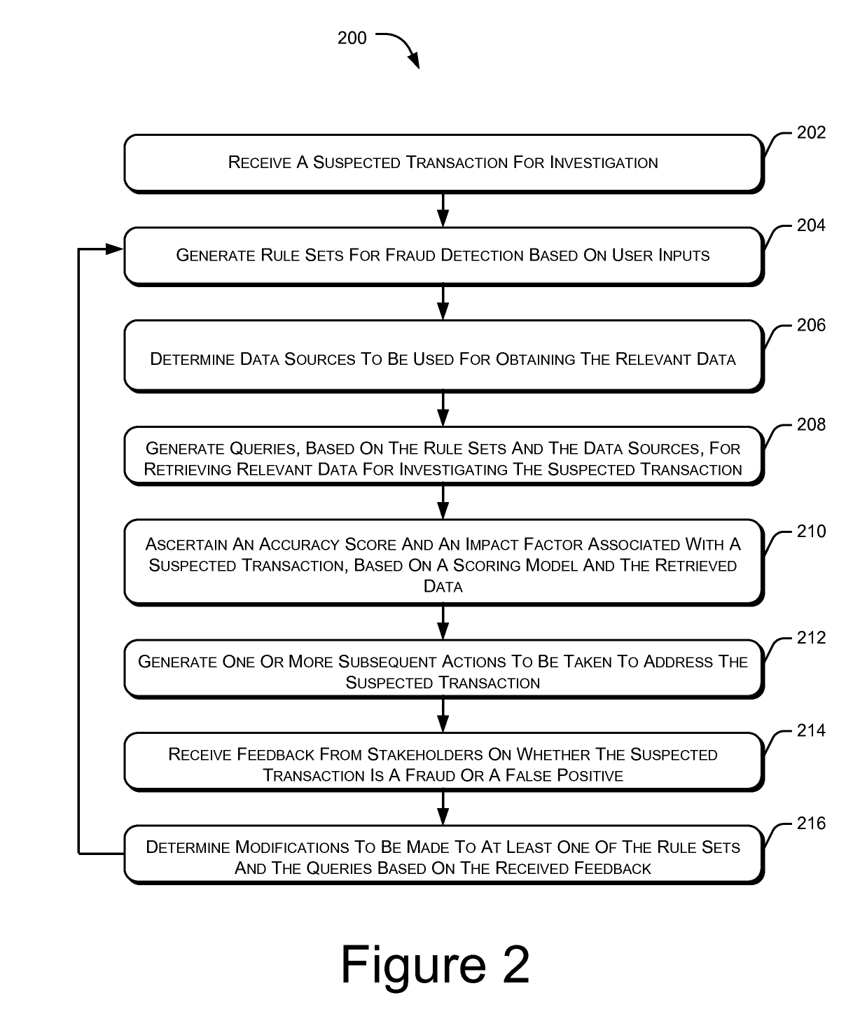

A computer implemented method for flagging one or more transactions as a potential fraudulent activity in an organization will now be explained in conjunction with FIG. 2. The method may involve receiving a suspected transaction for investigation at step 202. A suspected transaction may correspond to a transaction that is suspected to be fraudulent. The transaction may be suspected to be fraudulent either manually by an administrator or may be identified automatically based on that transaction deviating from a predefined normal behavior. The suspected transaction may include one or more sub-transactions. The sub-transactions may correspond to various events that occur in an organization or enterprise environment. To identify sub-transactions associated with a transaction, one or more sub-transactions associated with the organization may be monitored. Thereafter, breaches in the monitored sub-transactions may be identified and then patterns in the identified breaches may be determined. An accuracy score and an impact score may then be ascertained for the sub-transactions based on the determined patterns. Computation of the accuracy score and the impact score is explained in detail in conjunction with FIG. 1. The sub-transactions may then be classified as a single fraudulent transaction based on the determined patterns and one or more of the accuracy score and the impact score.

After receiving the suspected transaction, the suspected transaction may be classified into one or more groups of fraudulent activity. The groups may each correspond to a domain area associated with the fraud. Various parameters associated with the suspected transaction may be analyzed and accordingly the suspected transaction may be classified into one or more groups.

Once the suspected transaction is classified into one or more groups, one or more investigation rule sets may be created for investigating the suspected transaction at step 204. The rule sets may be created automatically based on the context for each domain of occupational fraud. A People, Location, Object, Time (PLOT) model may be used to generate rule sets specific to fraud domain. Generation of investigation rule sets is explained in detail in conjunction with FIG. 1.

On creation of various investigation rules to investigate the suspected transaction, data selection rules may be used to automatically determine data sources needed for each rule in the investigation rule set at step 206. The relevant data sources may be determined based on the various validations required for each element in the PLOT model. The data selection rules may enable selection of the data sources based on the relevance of the data source to the particular investigation rule, the quality of data, and the ease of access of the data. The data sources could include structured data as well as unstructured data. Structured data may include, but is not limited to, physical access records, network access and security logs, application transaction data, application logs, HR profile records, etc. Further, unstructured data may include, but is not limited to, email data, video conference logs, internet activity, video surveillance logs, social networking records, cell phone records, etc.

At step 208, queries may be generated to retrieve relevant data from the identified data sources for investigating the suspected transaction. Queries may be generated for primary level anomaly detection and aggregate level anomaly detection. Unearthing primary level anomalies and aggregate level anomalies are described in detail in conjunction with FIG. 1. A number of analysis methodologies may be used to uncover aggregate level anomalies. For example, a collusion network analysis may be used if anomalous behavior is not restricted to one individual but several individuals related to one other, a third party collusion analysis may be used if anomalous behavior is indicative of collusion between one or more employees and third party vendors, an anomaly chain analysis may be used to perform an end to end analysis that links a particular anomaly to other anomalous events that facilitated different anomalies. Further, an intersection analysis may be used if the same anomalous behavior is indicated by multiple algorithms of the same domain, a consequent event tracking may be performed if an individuals' actions post an anomalous behavior act as confirmatory indicator of initial anomalous action, and an intent analysis may be used to cover prediction of possible motives for confirmed anomalous activities.

Further, one or more of an organizational graph, related sub-transactions, and related transactions may be analyzed to determine patterns in the suspected transaction. The analysis may ascertain relationships between the users involved in one or more of the related sub-transactions, related transactions, and sub-transactions of the suspected transaction to identify group involvement in the suspected transaction. Thereafter, one or more of the accuracy score and the impact score associated with the suspected transaction may be revised based on at least one of the determined patterns and the ascertained relationships.

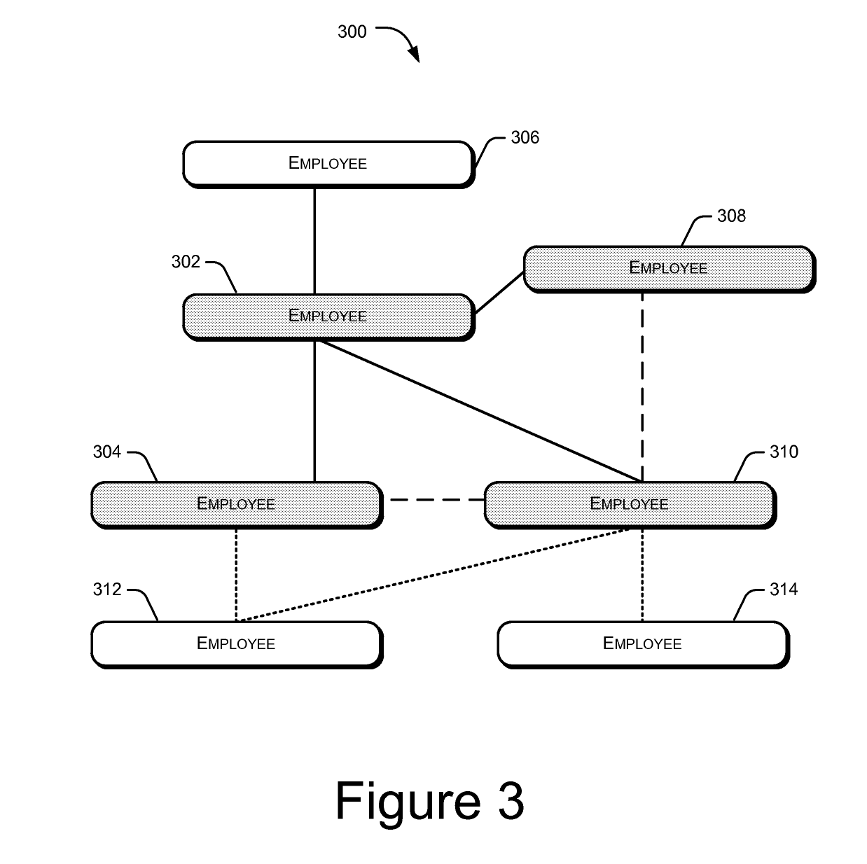

FIG. 3 illustrates an exemplary occupational graph used to perform collusion network analysis. Each employee such as employee 302, employee 304, employee 306, employee 308, employee 310, employee 312, and employee 314 may be represented by a node in the occupational graph. The employee involved in a primary level fraud may be represented differently such as employee 302, employee 304, employee 306, and employee 308. Each edge may be weighted based on the likelihood of collusive fraud which in turn is based on whether the employee was involved in a primary level fraud and the nature of the relationship. The nature of relationship may be:

Close relationships: Direct relationship, Peers in the same project team etc.

Loose relationship: Same University, same work area, etc.

The edge weights are calculated and collusive groups are determined based on the involvement in primary level fraud by the two employees and the nature of the relationship. For example, if employee 302 and employee 308 are in a reporting relationship in the organization such that employee 302 reports to employee 308 or vice versa and they are both involved in a primary level fraud, then the edge weights between employee 302 and employee 308 may be high to indicate possible collusion between the two employees. Thus, various weights may be pre-assigned to the different organizational relationships and accordingly aggregate level anomalies may be detected. As a further example, employee 304 and employee 310 may share a peer relationship (common role). In such a case, a weight slightly lower than that assigned between employee 302 and employee 308 may be assigned. The weights indicate the probability of collusion between the employees. Similarly, somewhat lower weights may be assigned between employees if they have basic commonalities such as working in the same area or from the same university, etc. These relationships may be represented visually differently on the occupational map to let an investigation user quickly identify cases of collusion.

On determining the suspected transaction is indeed a fraudulent activity, an accuracy score and an impact score may be ascertained for the suspected transaction at step 210. The accuracy score may indicate how accurate the prediction is and may be computed based on availability and number of corroborating sources, overall false positive rate for the scenario and quality of data sources. The impact score may indicate the impact of the fraud and may be computed based on the value of the transaction and also the domain criticality. A default weight may be assigned to each of the parameters while calculating the accuracy score and the impact score. These default weights may then be automatically updated based on feedback after the investigation process as described in conjunction with FIG. 1. The suspected transaction may be classified as a potential fraudulent activity if one or more of the accuracy score and the impact score exceed a pre-defined threshold.

On determining the accuracy score and the impact score for the suspected transaction, one or more actions may be generated to address the suspected transaction. The generation of the actions is explained in conjunction with FIG. 1. The subsequent actions may include, but are not limited to, blocking the suspected transaction, accepting the suspected transaction but sending real time alert for immediate tracking by investigators, accepting transaction with tracking in batch mode etc. The anomalous instance may then be assigned to an investigating user and if the aggregate level anomaly flag is set to true, then all the related anomalous events may be collated and assigned to the same investigating user.

Thereafter, at step 214, feedback may be received from various stakeholders on whether the suspected transaction is a fraud or a false positive. Based on the feedback, one or more of the investigation rules and the data selection rules may be modified at step 216. Additionally, the subsequent actions executed or suggested may also be modified based on the feedback provided by the investigating user.

The specification has described a method and system for flagging one or more transactions as a potential fraudulent activity. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. An organizational fraud detection (OFD) device comprising:
a processor;
a memory, wherein the memory coupled to the processor which are configured to execute programmed instructions stored in the memory comprising
receive a suspected transaction for investigation, wherein the suspected transaction comprises one or more sub-transactions;
classify the suspected transaction into one or more groups of fraudulent activity;
select, based on the classification, a set of investigation rules for investigating the suspected transaction;
determine, based on data selection rules, the data associated with the suspected transaction;
ascertain an accuracy score and an impact score associated with the suspected transaction; and
classify the suspected transaction as a potential fraudulent activity on at least one of the accuracy score and the impact score exceeding a pre-defined threshold.

2. The device, as claimed in claim 1, wherein the investigation rules are selected based on a People, Location, Object, Time (PLOT) model.

3. The device, as claimed in claim 1, wherein the instructions, on execution, further cause the processor to:
receive feedback on whether a suspected transaction, classified as a potential fraudulent activity, is one of a false positive or a fraud activity;
determine, based on the received feedback, modifications to be made to at least one of the investigation rules and data selection rules; and
amend at least one of the investigation rules and data selection rules, based on the determined modifications.

4. The device, as claimed in claim 1, wherein the instructions, on execution, further causes the processor to:
determine one or more data repositories which store the data associated with the suspected transaction; and
generate queries to retrieve the data associated with the suspected transaction from the one or more data repositories.

5. The device, as claimed in claim 1, wherein the instructions, on execution, further causes the processor to:
analyze at least one of an organizational graph, related sub-transactions, and related transactions to determine patterns in the suspected transaction;
ascertain relationships between the users involved in at least one of the related sub-transactions, related transactions, and sub-transactions of the suspected transaction to identify group involvement in the suspected transaction; and
revise at least one of the accuracy score and the impact score associated with the suspected transaction, based on at least one of the determined patterns and the ascertained relationships.

6. The device, as claimed in claim 1, wherein the instructions, on execution, further causes the processor to:
generate, based on at least one of the accuracy score and the impact score associated with the suspected transaction, one or more subsequent actions to mitigate the risks associated with the suspected transaction; and
execute the generated one or more subsequent actions.

7. The device as claimed in claim 1, wherein the instructions, on execution, further cause the processor to:
monitor one or more sub-transactions in an organization;
identify breaches in the monitored sub-transactions;
determine patterns in the identified breaches;
ascertain the accuracy score and the impact score associated with the sub-transactions, based on the determined patterns;
classify the sub-transactions as a single fraudulent transaction, based on the determined patterns and at least one of the accuracy score and the impact score.

8. A method for flagging one or more transactions as a potential fraudulent activity, in an organization, the method comprising:
receiving, by an organization fraud detection device, a suspected transaction for investigation, wherein the suspected transaction comprises one or more sub-transactions;
classifying, by the organization fraud detection device, the suspected transaction into one or more groups of fraudulent activity;
selecting, by the organization fraud detection device, based on the classification, a set of investigation rules for investigating the suspected transaction;
determining, by the organization fraud detection device, based on data selection rules, the data associated with the suspected transaction;
ascertaining, by the organization fraud detection device, an accuracy score and an impact score associated with the suspected transaction; and
classifying, by the organization fraud detection device, the suspected transaction as a potential fraudulent activity on at least one of the accuracy score and the impact score exceeding a pre-defined threshold.

9. The method as claimed in claim 8, wherein the investigation rules are selected based on a People, Location, Object, Time (PLOT) model.

10. The method as claimed in claim 8, wherein the method further comprises:
receiving, by the organization fraud detection device, feedback on whether a suspected transaction, classified as a potential fraudulent activity, is one of a false positive or a fraud activity;
determining, by the organization fraud detection device, based on the received feedback, modifications to be made to at least one of the investigation rules and data selection rules; and
amending, by the organization fraud detection device, at least one of the investigation rules and data selection rules, based on the determined modifications

11. The method as claimed in claim 8, wherein the method further comprises:
determining, by the organization fraud detection device, one or more data repositories which store the data associated with the suspected transaction; and
generating, by the organization fraud detection device, queries to retrieve the data associated from the one or more data repositories.

12. The method as claimed in claim 8, wherein the method further comprises:
analyzing, by the organization fraud detection device, at least one of an organizational graph, related sub-transactions, and related transactions to determine patterns in the suspected transaction;
ascertaining, by the organization fraud detection device, relationships between the users involved in at least one of the related sub-transactions, related transactions, and sub-transactions of the suspected transaction to identify group involvement in the suspected transaction; and
revising, by the organization fraud detection device, at least one of the accuracy score and the impact score associated with the suspected transaction, based on at least one of the determined patterns and the ascertained relationships.

13. The method as claimed in claim 8, wherein the method further comprises:
generating, by the organization fraud detection device, based on at least one of the accuracy score and the impact score associated with the suspected transaction, one or more subsequent actions to mitigate the risks associated with the suspected transaction; and
executing, by the organization fraud detection device, the generated one or more subsequent actions.

14. The method as claimed in claim 8, wherein the method further comprises:
monitoring, by the organization fraud detection device, one or more sub-transactions in an organization;
identifying, by the organization fraud detection device, breaches in the monitored sub-transactions;
determining, by the organization fraud detection device, patterns in the identified breaches;
ascertaining, by the organization fraud detection device, the accuracy score and the impact score associated with the sub-transactions, based on the determined patters;
classifying, by the organization fraud detection device, the sub-transactions as a single fraudulent transaction, based on the determined patterns and at least one of the accuracy score and the impact score.

15. A non-transitory computer readable medium having stored thereon instructions for flagging one or more transactions as a potential fraudulent activity in an organization comprising machine executable code which when executed by at least one processor, causes the processor to perform steps comprising:
receiving a suspected transaction for investigation, wherein the suspected transaction comprises one or more sub-transactions;
classifying the suspected transaction into one or more groups of fraudulent activity;
selecting, based on the classification, a set of investigation rules for investigating the suspected transaction;
determining, based on data selection rules, the data associated with the suspected transaction;
ascertaining an accuracy score and an impact score associated with the suspected transaction; and
classifying the suspected transaction as a potential fraudulent activity on at least one of the accuracy score and the impact score exceeding a pre-defined threshold.

16. The non-transitory computer readable medium as claimed in claim 15, wherein the investigation rules are selected based on a People, Location, Object, Time (PLOT) model.

17. The non-transitory computer readable medium as claimed in claim 15, wherein the set of computer executable instructions, which, when executed on the computing system causes the computing system to further perform the steps of:
receiving feedback on whether a suspected transaction, classified as a potential fraudulent activity, is one of a false positive or a fraud activity;
determining, based on the received feedback, modifications to be made to at least one of the investigation rules and data selection rules; and
amending at least one of the investigation rules and data selection rules, based on the determined modifications

18. The non-transitory computer readable medium as claimed in claim 15, wherein the set of computer executable instructions, which, when executed on the computing system causes the computing system to further perform the steps of:
determining one or more data repositories which store the data associated with the suspected transaction; and
generating queries to retrieve the data associated from the one or more data repositories.

19. The non-transitory computer readable medium as claimed in claim 15, wherein the set of computer executable instructions, which, when executed on the computing system causes the computing system to further perform the steps of:
analyzing at least one of an organizational graph, related sub-transactions, and related transactions to determine patterns in the suspected transaction;
ascertaining relationships between the users involved in at least one of the related sub-transactions, related transactions, and sub-transactions of the suspected transaction to identify group involvement in the suspected transaction; and
revising at least one of the accuracy score and the impact score associated with the suspected transaction, based on at least one of the determined patterns and the ascertained relationships.

20. The non-transitory computer readable medium as claimed in claim 15, wherein the set of computer executable instructions, which, when executed on the computing system causes the computing system to further perform the steps of:
generating, based on at least one of the accuracy score and the impact score associated with the suspected transaction, one or more subsequent actions to mitigate the risks associated with the suspected transaction; and
executing the generated one or more subsequent actions
